(19) United States
(12) Patent Application Publication
(10) Pub. No.: US 2019/0251070 A1
(43) Pub. Date: Aug. 15, 2019

(54) ANALYSIS SUPPORT SYSTEM AND METHOD

(71) Applicant: HITACHI, LTD., Tokyo (JP)

(72) Inventors: Takahisa NAKAZAWA, Tokyo (JP); Akihisa NAGAMI, Tokyo (JP); Osamu KUBOTA, Tokyo (JP); Youhei NOZAKI, Tokyo (JP); Masashi FUKUI, Tokyo (JP)

(73) Assignee: HITACHI, LTD., Tokyo (JP)

(21) Appl. No.: 16/329,249

(22) PCT Filed: Aug. 3, 2017
(86) PCT No.: PCT/JP2017/028172

§ 371 Date: Feb. 28, 2019

(51) Int. Cl. G06F 16/22; G06F 16/2458; G06F 17/15

(52) U.S. Cl. CPC G06F 16/2291; G06F 17/15; G06F 16/2465

(57) ABSTRACT

An analysis support system stores one or more templates each prepared according to an analysis purpose. Each of the one or more templates is correlated with: one or more data item names related to at least one of the one or more analysis target systems; and a log level that allows output of data of each of the one or more data item names. The analysis support system receives the selection of a template among one or more templates. The analysis support system uses data of a data item name as analysis data, the data being data of one or more data item names correlated with the selected template, the data item name corresponding to a log level equal to or lower than an allowable log level among pieces of data of the analysis target system correlated with the selected template.

### TECHNICAL FIELD

The present invention generally relates to supporting data analysis.

### BACKGROUND ART

In recent years, with progress in IoT (Internet of Things) devices, for example, it became possible to acquire real-time data using sensors and the like. Moreover, a processing speed of databases has increased and it became possible to extract and handle a large amount of data. With these technical progresses, technologies for analyzing collected data and utilizing the same in business management are being developed actively.

A technology disclosed in PTL 1, for example, is known as a technology related to data analysis support. In the technology of PTL 1, an analysis provider registers analysis support information in advance in a support information DB of an analysis support system. The analysis support information includes information indicating an analysis purpose and a data item. When an analysis purpose and a data item are input from an analysis user, the analysis support system extracts data most similar to the input analysis purpose and data item from the support information DB.

### CITATION LIST

### Patent Literature

### PTL 1

Japanese Patent Application Publication No. 2010-205218

### SUMMARY OF INVENTION

### Technical Problem

However, PTL 1 has at least one of the problems including a problem that it is not always guaranteed that data necessary for data analysis is acquired to extract similar data and a problem that data is acquired even if the data is not necessary for data analysis.

Generally, in companies, a system administrator of a system that outputs data is a person different from an analyzer who analyzes data. Generally, a system administrator does not understand which result is obtained when which data among a large amount of collected data is analyzed. Therefore, an interaction between the analyzer and the system administrator is required. For example, such an interaction that the analyzer delivers the purpose of analysis to the system administrator, hears a providable data item from the system administrator, selects a data item considered to be necessary for the purpose of analysis, and asks the system administrator to provide the data of the selected data item.

A main object of the present invention is to solve the above-described problems and support data analysis by an analyzer.

### Solution to Problem

An analysis support system stores one or more templates each prepared according to an analysis purpose. Each of one or more templates is correlated with: one or more data item names related to at least one of the one or more analysis target systems; and a log level that allows output of data of each of the one or more data item names. The analysis support system receives the selection of a template among one or more templates. The analysis support system uses data of a data item name corresponding to a log level equal to or lower than an allowable log level among pieces of data of the analysis target system correlated with the selected template, the data being data of one or more data item names correlated with the selected template, as analysis data.

### Advantageous Effects of Invention

An analyzer can acquire data necessary for analysis without any interaction with a system administrator.

### BRIEF DESCRIPTION OF DRAWINGS

FIG. 1 is a block diagram illustrating an entire system including an analysis support system according to an embodiment.

FIG. 2 is a diagram of a base table.

FIG. 3 is a diagram of a log table.

FIG. 4 is a diagram of a system table.

FIG. 5 is a diagram of a log output management table.

FIG. 6 is a flowchart illustrating an overview of a process performed in an embodiment.

FIG. 7 is a diagram of a log output management table after change.

FIG. 8 is a diagram of a display target analysis table.

FIG. 9 is a flowchart of a log acquisition process.

FIG. 10 is a flowchart of a table generation process.

### DESCRIPTION OF EMBODIMENTS

In the following description, an “interface unit” may include at least one of a user interface unit and a communication interface unit. A user interface unit may include at least one I/O device among one or more I/O devices (for example, an input device (for example, a keyboard and a pointing device) and an output device (for example, a display device)) and a display computer. The communication interface unit may include one or more communication interface devices. One or more communication interface devices may be one or more communication interface devices (for example, one or more NICs (Network Interface Cards)) of the same type and may be two or more communication interface devices (for example, NIC and a HBA (Host Bus Adapter)) of different types.

In the following description, a “storage unit” includes at least a memory unit among a memory unit and a PDEV unit. The PDEV unit includes one or more PDEVs. The memory unit includes one or more memories. At least one memory may be a volatile memory and may be a nonvolatile memory. The storage unit is mainly used when a processor unit executes processing.

In the following description, a “processor unit” includes one or more processors. At least one processor is typically a CPU (Central Processing Unit). A processor may include a hardware circuit that performs a part or all of processes.

Moreover, in the following description, although information is sometimes described using an expression of an “xxx table, ” the information may be expressed by an arbitrary data structure. That is, the “xxx table” may be referred to as “xxx information” in order to show that information does not depend on a data structure. Moreover, in the following description, the configuration of each table is an example, one table may be divided into two or more tables, and all or a portion of two or more tables may be integrated into one table.

In the following description, there may be cases where processing is described using a “program” as the subject. However, since the processing is performed while using a storage unit (for example, a memory) and/or an interface device (for example, a communication port) as necessary when a program is executed by a processor (for example, a CPU (Central Processing Unit)), a processor (or an apparatus or a system including the processor) may also be used as the subject of the processing. Moreover, the processor may include a hardware circuit that performs a part or all of the processes. A program may be installed in an apparatus such as a computer from a program source. The program source may be a program distribution server or a computer-readable (for example, non-transitory) recording medium, for example. Moreover, in the following description, two or more programs may be implemented as one program, and one program may be implemented as two or more programs.

In the following description, a “PDEV” means a physical storage device and typically may be a nonvolatile storage device (for example, an auxiliary storage device). For example, the PDEV is a HDD (Hard Disk Drive) or a SSD (Solid State Drive).

In the following description, a “storage system” includes one or more physical storage apparatuses. At least one physical storage apparatus may be a general-purpose physical computer. At least one storage apparatus may execute a virtual computer (for example, a VM (Virtual Machine)) and may execute a SDx (Software-Defined anything). As the SDx, a SDS (Software Defined Storage) (an example of a virtual storage apparatus) or a SDDC (Software-defined Datacenter) may be used.

in the following description, when the same types of elements are not distinguished from each other, common portions in the reference numerals may be used, whereas when the same types of elements are distinguished from each other, the reference numerals of the elements may be used.

In the following description, an analysis support system may include one or more computers. Displaying of information by the analysis support system may be realized by displaying information on a display device of the analysis support system or by transmitting display information to a display computer (an analysis client) at a remote site.

Hereinafter, an embodiment will be described with reference to the drawings.

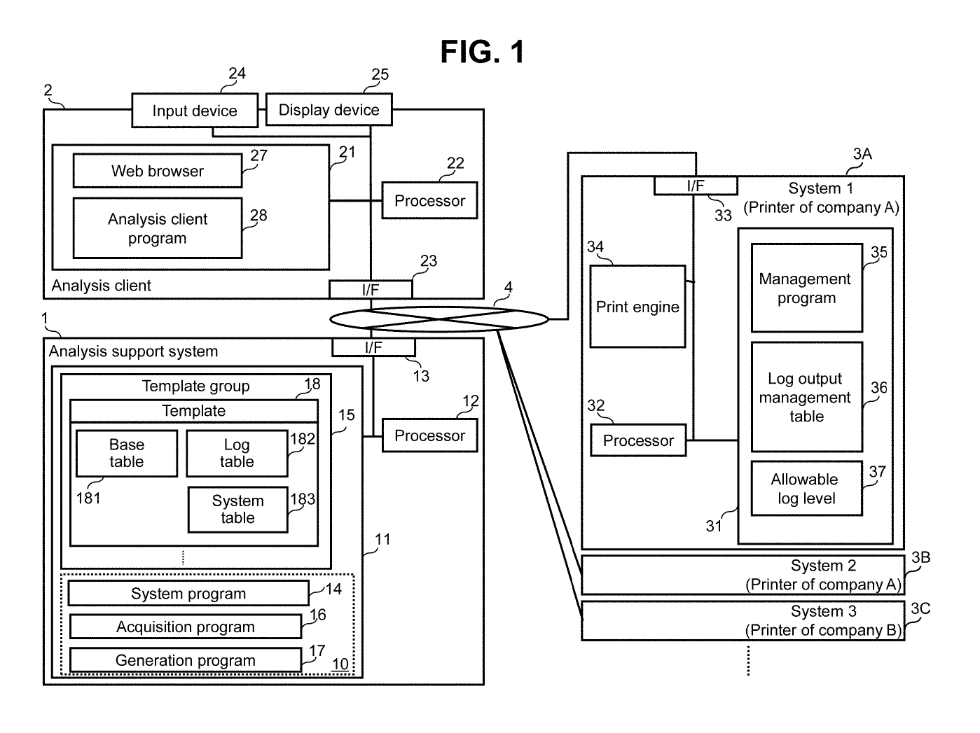

FIG. 1 is a block diagram illustrating an entire system including an analysis support system according to an embodiment.

An analysis support system 1 is connected to one or more analysis clients 2 and one or more analysis target systems 3 (for example, 3A to 3C) via a network (for example, a LAN (Local Area Network) or the Internet) 4.

The analysis client 2 is a computer and includes an I/F 23, an input device 24, a display device 25, a storage unit 21, and a processor 22 connected to these components.

The storage unit 21 stores a computer program such as a Web browser 27 and an analysis client program 28. The Web browser 27 is a browser provided for use in the World Wide Web (WWW). The analysis client program 28 is a program for controlling the analysis client 2.

The processor 22 controls the analysis client 2 by executing the analysis client program 28. Moreover, the processor 22 displays a GUI (Graphical User Interface) from the analysis support system 1 by executing the Web browser 27.

The I/F 23 is a communication interface device (for example, a NIC (Network Interface Card)) for performing communication via the network 4.

The input device 24 is a printer control device and a keyboard, for example. The display device 25 is a device having a physical screen on which information is displayed and is a liquid crystal display device, for example.

The plurality of analysis target systems 3 may be printers, for example, and instead of printers, may be one or more types of systems (for example, a computer system, a wind power generation apparatus, an electric train, or an air-conditioning apparatus). An analysis target system 3A as a printer includes a print engine 34, a storage unit 31, an I/F 33, and a processor 32 connected to these components. Any one of the analysis target systems 3 includes at least the storage unit 31, the I/F 33, and the processor 32 connected to these components.

The storage unit 31 stores a program such as a management program 35 and information such as a log output management table 36 and an allowable log level 37. The management program 35 is a program for managing the analysis target system 3. The log output management table 36 manages logs (data) and a data item managed by the analysis target system 3. The allowable log level 37 is a log level allowed among a plurality of levels of log levels meaning a plurality of levels of intensities of output of logs. That is, the allowable log level 37 restricts a data item which is allowed to be output among a plurality of data items managed by the analysis target system 3. The higher the value of the allowable log level 37, the larger the number of data items which are allowed to be output. The management program 35 may be configured to output the log of a data item name corresponding to a log level equal to or smaller than the allowable log level 37 and do not output the log of a data item name corresponding to a log level exceeding the allowable log level 37. When the management program 35 is configured in this manner, by changing the allowable log level 37, it is possible to increase or decrease the number of data item names which are allowed to be output.

The processor 32 controls the analysis target system 3 by executing the management program 35.

The I/F 33 is a communication interface device (for example, an NIC) for performing communication via the network 4.

The analysis support system 1 includes a storage unit 11, an I/F 13, and a processor 12 connected to these components. The I/F 13 is an example of an interface unit. The processor 12 is an example of a processor unit.

The storage unit 11 stores a computer program such as an analysis support program 10 and information such as a template group 15. The analysis support program 10 includes a system program 14, an acquisition program 16, and a generation program 17. The system program 14 receives the selection of a template 18 from an analyzer and calls the acquisition program 16 and the generation program 17. The acquisition program 16 acquires the log output management table 36 from the analysis target system 3. The generation program 17 creates an analysis table (an example of an analysis data) on the basis of the selected template 18 and the acquired log output management table 36.

The processor 12 controls the analysis support system 1 by executing the analysis support program 10.

The I/F 13 is a communication interface device (for example, an NIC) for performing communication via the network 4.

The template group 15 includes one or more templates 18. The template 18 is data for creating an analysis table corresponding to the purpose of analysis. The “analysis purpose” may be an abstract purpose (for example, analysis of the use state of a printer) and may be a specific purpose (for example, analysis of a causal relationship between a printer arrangement, a time period, and the number of prints). The template 18 includes a base table 181, a log table 182, and a system table 183.

A control program 10 that controls the analysis support system 1 and a virtual computer operating as the analysis client 2 may be executed on a physical computing resource of the same computing system (for example, a cloud computing system).

The log levels 37 of the respective analysis target systems 3 may be set in the storage unit 11 of the analysis support system 1 instead of or in addition to the log level 37 being set to each analysis target system 3 in the analysis target systems 3.

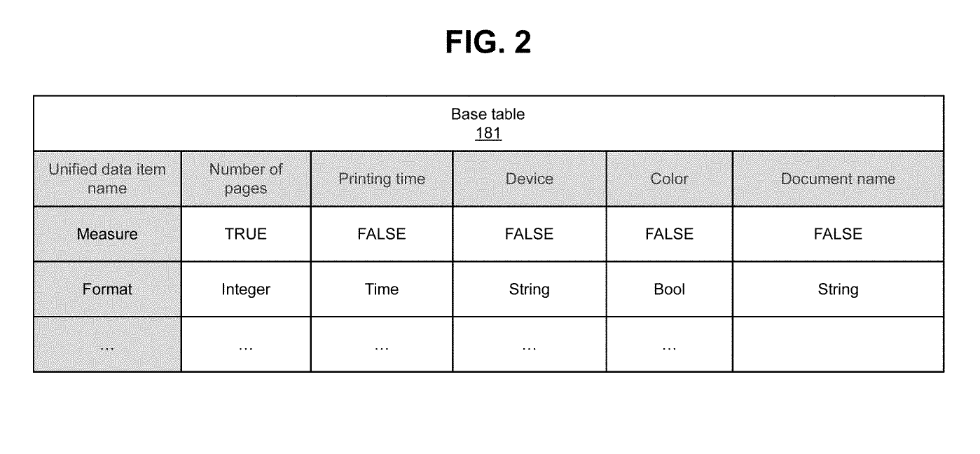

FIG. 2 illustrates an example of the base table 181.

The base table 181 is a table serving as the base of an analysis table and defines a data item name necessary for analysis of the analysis target system 3 and a data output method. For example, unified data item names are defined in the base table 181. Moreover, the unified data item names include “number of pages”, “printing time”, “device”, “color”, and “document name”. A measure and a data format are also defined for each unified data item name. The base table 181 may be created by an external template creator and be provided from the outside.

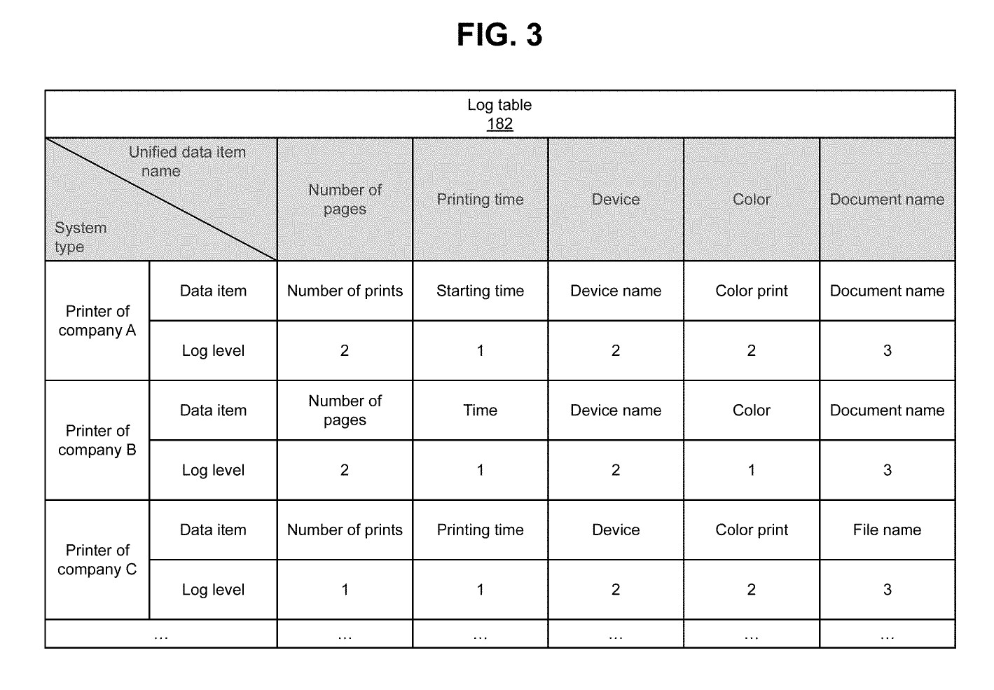

FIG. 3 illustrates an example of the log table 182.

The log table 182 is a table for associating the base table 181 with the log output management table 36 of the analysis target system 3.

For example, the log table 182 defines a data item name (an individual data item name) and a log level for respective system types with respect to each of the plurality of unified data item names.

The “system type” is a type, for example, a manufacturer of a printer, of the analysis target system 3 and may be a more detailed type such as a printer model. According to the illustrated example, a data item name corresponding to a unified data item name of “number of pages” is “number of prints” for printers of companies A and C whereas the data item name is “number of pages” for printers of company B. In this manner, even if data items are the same (substantially the same), the data item names may be different depending on a system type. A variation in data item name resulting from a difference in system type is absorbed in a common data item name called the unified data item name.

A log level correlated with a data item name indicates a highest value of the allowable log level 37 that allows output of logs (data) belonging to the data item name. Therefore, logs belonging to a data item name correlated with a log level (a log level equal to or lower than the allowable log level 37) equal to or smaller than the allowable log level 37 are output.

The log table 182 may be created by an external template creator and be provided from the outside.

Although the illustrated log table 182 stores data item names and log levels for all system types, the log table 182 may store data item names and log levels for one system type only. That is, the template 18 may be data for creating an analysis table corresponding to one system type and may be data for creating an analysis table corresponding to a plurality of system types.

Although the log table 182 (and the base table 181) has unified data item names for printers, the log table 182 may have unified data item names for another type of systems like computer systems instead of or in addition to the unified data item names for printers. That is, an analysis target of one template 18 may be a printer only and may be a system (for example, a computer system) different from the printer instead of or in addition to the printer. The know-how of a template creator can be applied to the template 18.

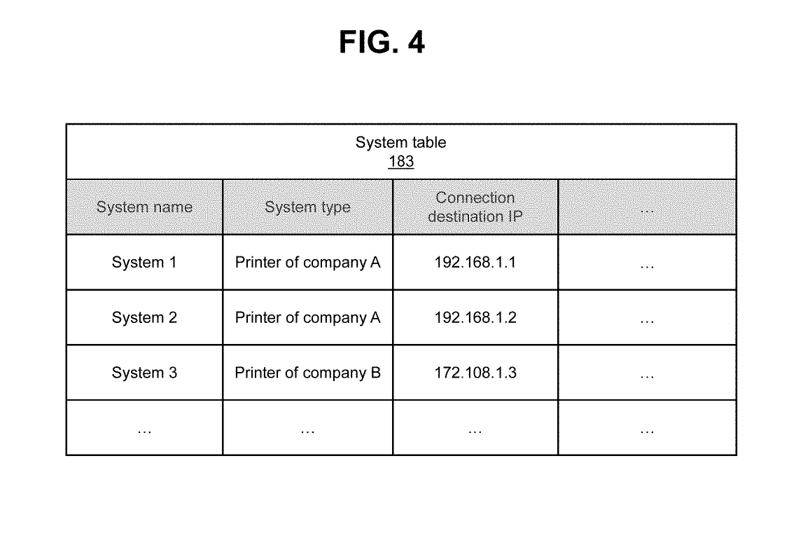

FIG. 4 illustrates an example of the system table 183.

The system table 183 is a table for associating the analysis target system 3 with the connection information of the analysis target system 3. For example, the system table 183 defines a system name, a system type, and a connection destination IP of each of a plurality of analysis target systems 3. The system name is the name of the analysis target system 3. The connection destination IP is an IP address of the analysis target system 3.

Even when the respective values of the system table 183 are not recorded when the template 18 is created, a system administrator (for example, a system engineer) of the analysis support system 1 may complement the values before analysis is performed.

Although the illustrated system table 183 has rows (entries) for all systems 3, the system table 183 may have rows for at least one system 3.

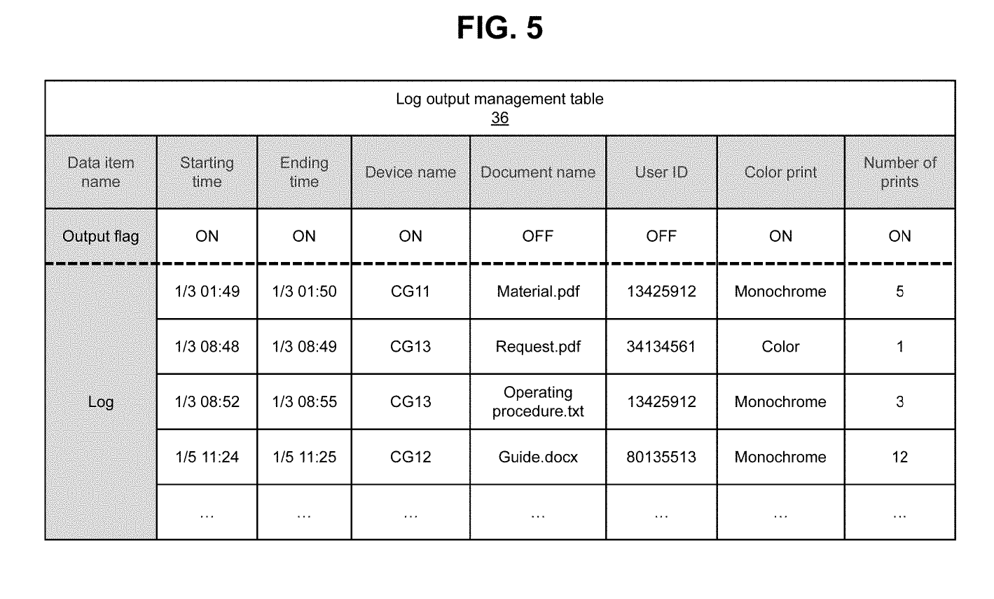

FIG. 5 illustrates an example of the log output management table 36.

The log output management table 36 stores an output flag and logs for respective data item names (individual data item names). For each data item name, an output flag indicates whether logs belonging to the data item name will be output. “ON” means that logs are output (output allowed) and “OFF” means that logs are not output. For each data item name, logs are data including one or more values collected for the data item name.

In the log output management table 36, an output flag corresponding to a data item name corresponding to a log level equal to or smaller than the allowable log level 37 is set to “ON”, and an output flag corresponding to a data item name corresponding to a log level exceeding the allowable log level 37 is set to “OFF”.

The data item names illustrated in FIG. 5 are data item names related to the analysis target system 3A.

Hereinafter, an example of processes performed in the present embodiment will be described.

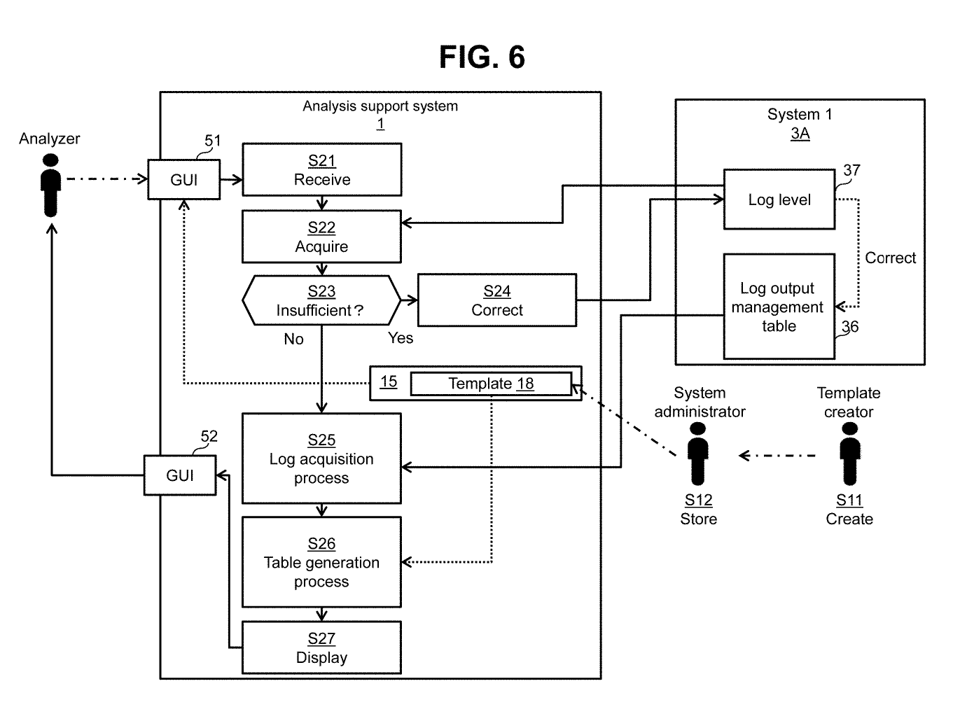

FIG. 6 illustrates the flow of an example of an entire analysis support process.

As a precondition, a template creator creates the template 18 (S11). In the template 18 created in S11, the connection destination IP of the system table 18 is blank. A system administrator complements the connection destination IP. The complemented template 18 is stored in the template group 15 of the analysis support system 1 (S12).

An analyzer selects a template 18 corresponding to the analysis purpose from the template group 15 through a GUI (Graphical User Interface) 51.

The system program 14 receives the selection of the template 18 selected by the analyzer through the GUI 51 (S21). The GUI 51 is provided from the system program 14 and is displayed by the Web browser 27 of the analysis client 2. The system program 14 may receive the input of an analysis purpose from an analyzer, find one or more templates 18 corresponding to the analysis purpose from the template group 15, display an overview of the found one or more templates 18 (for example, a list of unified data item names for each template 18), and receive the selection of the template 18 from the analyzer having watched the display. For each template 18, an analysis purpose may be correlated with the template 18.

Subsequently, the system program 14 connects to the analysis target system 3A on the basis of the system type and the connection destination IP recorded in the system table 183 included in the selected template 18 and acquires the allowable log level 37 from the connected system 3A (S22). In this manner, since the connection destination IP of the analysis target system 3A is described in the template 18, it is efficient.

Subsequently, the system program 14 determines whether any one of log levels in the selected template 18 is smaller than the acquired log level 37 (S23).

When a determination result in S23 is true, the system program 14 increases the log level 37 of the analysis target system 3A to the highest log level within the selected template 18 (S24). In response to correction of the allowable log level 37, an output flag corresponding to the data item name corresponding to the log level identical to the allowable log level 37 after correction may be changed from “OFF” to “ON” by the management program 35 of the analysis target system 3A.

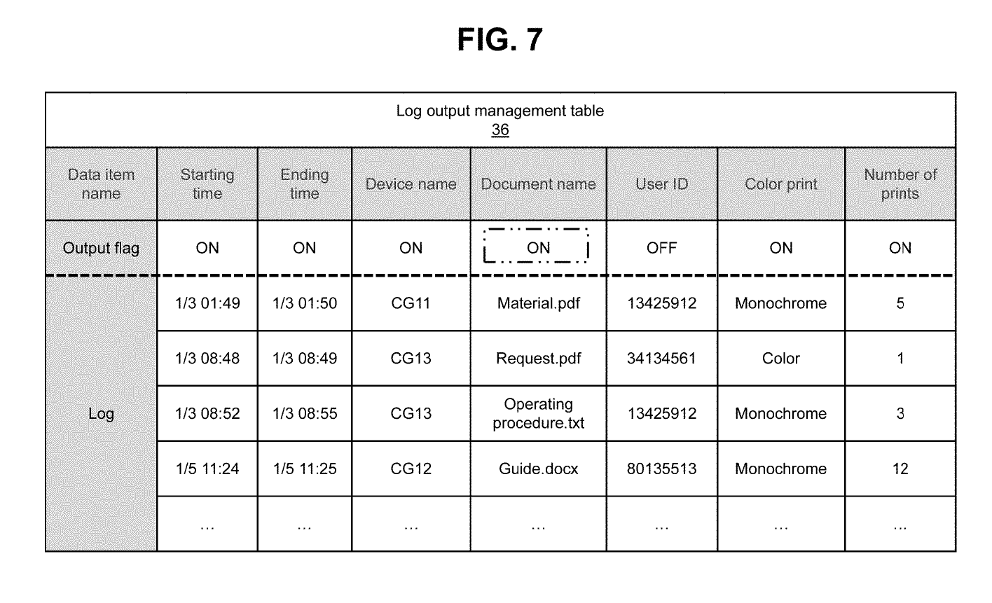

When a determination result in S23 is false or subsequently to S24, the acquisition program 16 is called from the system program 14 to execute a log acquisition process of acquiring the log output management table 36 from the analysis target system 3A (S25). In the log acquisition process, when an output flag corresponding to the data item name corresponding to the log level identical to the allowable log level 37 after correction among the output flags in the acquired log output table 36 is “OFF”, the acquisition program 16 changes the output flag to “ON”. For example, when the allowable log level 37 is changed from “2” to “3” for the analysis target system 3A, according to the log table 182 illustrated in FIG. 3, an output flag “OFF” corresponding to the data item name “document name” illustrated in FIG. 5 is changed to “OFF” as indicated by a two-dot-chain-line frame in FIG. 7.

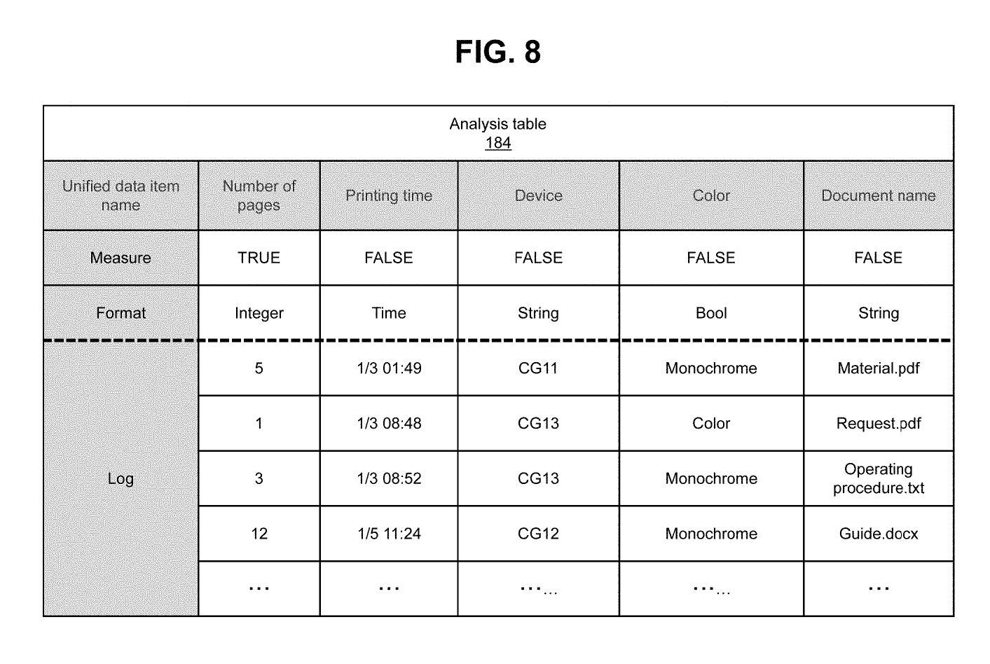

Subsequently to S25, the generation program 17 is called from the system program 14 to execute a table generation process of generating an analysis table (S26). According to the base table 181 illustrated in FIG. 2, the log table 182 illustrated in FIG. 3, and the log output management table 36 illustrated in FIG. 7, the analysis table 184 illustrated in FIG. 8 is generated. That is, the analysis table 184 includes a unified data item name and a measure corresponding to the data item name corresponding to the output flag “ON” and logs of the data item name corresponding to the output flag “ON”.

Lastly, the system program 14 displays the GUI 52 that displays the analysis table 184 (S27). The GUI 52 is provided from the system program 14 and is displayed by the Web browser 27 of the analysis client 2. The analysis table 184 may be stored in a predetermined database instead of or in addition to being displayed. The analysis table 184 may be read from the database at an arbitrary timing by the analyzer and be provided to the analysis client 2.

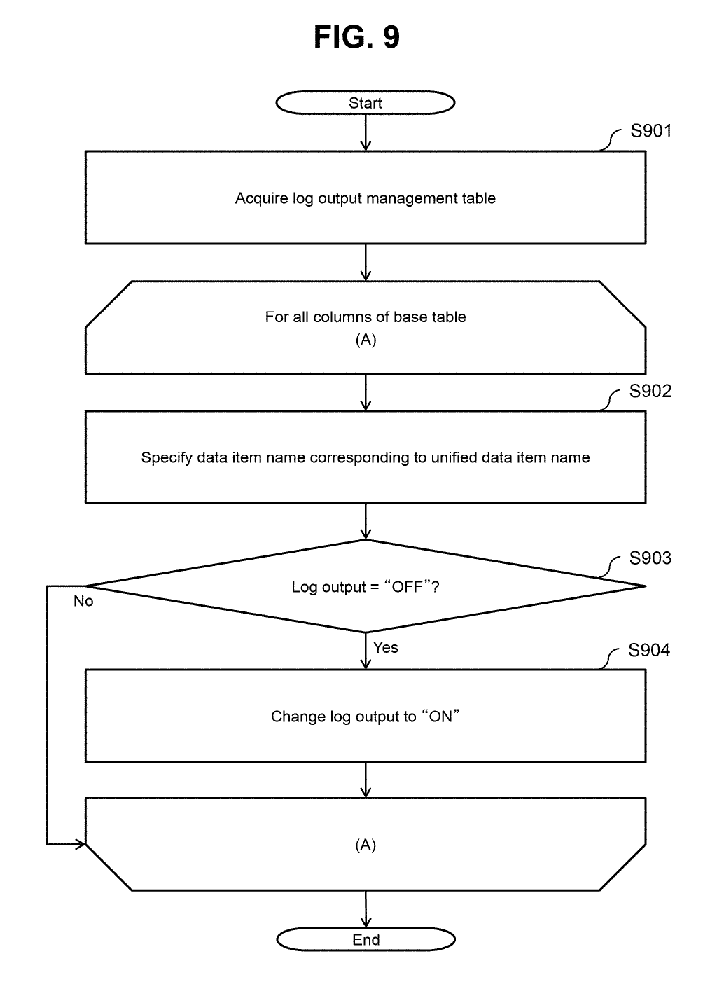

FIG. 9 illustrates an example of the flow of a log acquisition process (S25).

The acquisition program 16 acquires the present log output management table 36 (see FIG. 5) from the connected analysis target system 3A (S901). The acquisition program 16 performs S902 to S904 for all columns (all unified data item names) in the base table 181. Hereinafter, in FIG. 9, the process for one unified data item name will be described.

the acquisition program 16 specifies a data item name corresponding to the unified data item name from the log table 182 with respect to the connected system 3A (S902). Subsequently, in spite of the fact that the log level corresponding to the specified data item name is equal to or smaller than the allowable log level 37 (the allowable log level 37 after correction when the allowable log level 37 is corrected), the acquisition program 16 determines whether the output flag corresponding to the data item name is “OFF” (for example, whether the output flag of “document name” corresponding to the log level identical to the corrected allowable log level 37 of “3” is “OFF”) (S903). When a determination result in S903 is true (S703: YES), the acquisition program 16 changes the output flag corresponding to the data item name to “ON” (output).

When S902 to S904 are performed for all columns of the base table 181, the output flag of the corresponding data item name is changed to the value corresponding to the allowable log level 37 for each of the unified data item names.

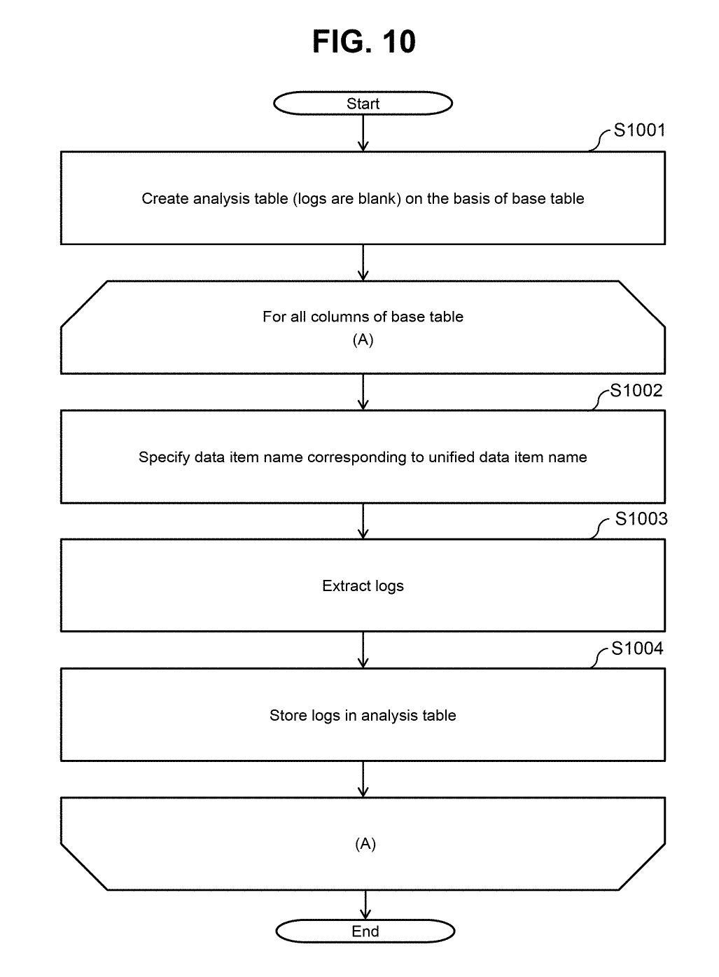

FIG. 10 illustrates an example of the flow of a table generation process (S26).

The generation program 17 records the unified data item name (and a measure) of the base table 181 and creates the analysis table 184 in which logs are left blank (S1001). The generation program 17 performs S1002 to S1004 for all columns (all unified data item names) in the base table 181. Hereinafter, in FIG. 10, the process for one unified data item name will be described.

The generation program 17 specifies a data item name corresponding to the unified data item name from the log table 182 with respect to the connected system 3A (S1002). For example, it is specified that the data item name of “number of prints” of the system 3A corresponds to the unified data item name of “number of pages”. The generation program 17 extracts logs of the specified data item name (values (data) in a column corresponding to the specified data item name) from the log output management table 36 (S1003). The generation program 17 stores the extracted logs in the column corresponding to the unified data item name in the analysis table 184 (S1004).

When S1002 to S1004 are performed for all columns of the base table 181, the analysis table 184 is formed.

According to the present embodiment, the analysis support system 1 stores one or more templates 18. One or more data item names for at least one of one or more analysis target systems 3 and a log level that allows output of data of each of one or more data item names are correlated with each of one or more templates. The analysis support program 10 receives the selection of a template 18 among one or more templates 18. The analysis support program 10 sets logs of a data item name corresponding to a log level equal to or lower than the allowable log level 37 among pieces of data of the analysis target system 3 correlated with the selected template 18, the data being of one or more data item names correlated with the selected template 18, to the analysis table 184. In this way, an analyzer can acquire data of a data item name necessary for analysis without any interaction with a system administrator.

When the allowable log level 37 of the analysis target system 3 correlated with the selected template 18 is lower than the highest value of one or more log levels respectively corresponding to one or more data item names correlated with the selected template 18, the analysis support program 10 increases the allowable log level 37 to the highest value. In this way, the value of the log level 37 of the analysis target system 3 can be decreased to reduce the amount of data output during normal operations and the allowable log level 37 can be increased to acquire logs of necessary data item names when performing analysis only.

The embodiment of the present invention is an example for describing the present invention, and it is not intended to limit the scope of the present invention to the embodiment only. A person of ordinary skill in the art can implement the present invention in various other manners without departing from the spirit of the present invention.

For example, the acquisition program 16 (or the management program 35) may change an output flag to “OFF” when the output flag is set to “ON” in spite of the fact that a data item name corresponds to a log level exceeding the allowable log level 37 (for example, the log level 37 after correction). In this way, it is possible to prevent output of logs unnecessary for analysis.

For example, at least one of the base table 181, the log table 182, and the system table 183 may be prepared independently, and the base table 181, the log table 182, and the system table 183 may be correlated with the template 18.

For example, the management program 35 of the analysis target system 3 may output logs if the output flag for each data item name is “ON” and may not output logs if the output flag is “OFF”. When the allowable log level 37 in the analysis target system 3 is corrected, the management program 35 of the analysis target system 3 may change the output flag corresponding to the data item name corresponding to the log level identical to the allowable log level 37 after correction from “OFF” to “ON”. The management program 35 may output a data item name and logs corresponding to the data item name of which the output flag is “ON” to the analysis support system 1 and may not output a data item name and logs corresponding to the data item name of which the output flag is “OFF”.

### REFERENCE SIGNS LIST

1 Analysis support system

1. An analysis support system comprising:
an interface unit including one or more communication interface devices connected to one or more analysis target systems;
a storage unit configured to store one or more templates each prepared according to an analysis purpose and include one or more memories; and
a processor unit including one or more processors connected to the interface unit and the storage unit, wherein
each of the one or more templates is correlated with:
one or more data item names related to at least one of the one or more analysis target systems; and
a log level that allows output of data of each of the one or more data item names, and
the processor unit is configured to:
receive the selection of a template among the one or more templates; and
use data of a data item name corresponding to a log level equal to or lower than an allowable log level among pieces of data of the analysis target system correlated with the selected template, the data being data of a plurality of data item names correlated with the selected template, as analysis data.

2. The analysis support system according to claim 1, wherein
the processor unit is configured to increase the allowable log level to a highest log level when the allowable log level is lower than the highest log level among a plurality of log levels respectively corresponding to the plurality of data item names correlated with the selected template.

3. The analysis support system according to claim 2, wherein
the allowable log level is set in the analysis target system correlated with the selected template, and
the processor unit is configured to increase the allowable log level set to the analysis target system.

4. The analysis support system according to claim 3, wherein
the processor unit is configured to receive data of a data item name corresponding to a log level equal to or lower than the allowable log level set among pieces of data of the analysis target system from the analysis target system correlated with the selected template and uses the received data as the analysis data.

5. The analysis support system according to claim 1, wherein
the processor unit is configured to:
when a data item name which is allowed to be output is present among one or more data item names correlated with the selected template even if the log level of the data item name exceeds the allowable log level, inhibit output of data of the data item name.

6. The analysis support system according to claim 1, wherein
each of the one or more templates is correlated with at least one connection destination address of the one or more analysis target systems, and
the processor unit is configured to connect to an analysis target system correlated with the selected template using the connection destination address correlated with the selected template.

7. The analysis support system according to claim 1, wherein
each of the one or more templates is further correlated with relationship between the one or more unified data item names and the one or more data item names related to at least one of the one or more analysis target systems, and
the processor unit is configured to includes data of a data item name corresponding to a log level equal to or lower than the allowable log level in the analysis data as data of the unified data item name corresponding to the data item.

8. An analysis support method comprising:
receiving the selection of a template among one or more templates each prepared according to an analysis purpose;
correlating each of the one or more templates with:
one or more data item names related to at least one of the one or more analysis target systems; and
a log level that allows output of data of each of the one or more data item names; and
using data of a data item name corresponding to a log level equal to or lower than an allowable log level among pieces of data of the analysis target system correlated with the selected template, the data being data of one or more data item names correlated with the selected template, as analysis data.

9. A computer program for causing a computer to execute:
receive the selection of a template among one or more templates each prepared according to an analysis purpose;
correlate each of the one or more templates with:
one or more data item names related to at least one of the one or more analysis target systems; and
a log level that allows output of data of each of the one or more data item names; and
use data of a data item name corresponding to a log level equal to or lower than an allowable log level among pieces of data of the analysis target system correlated with the selected template, the data being data of one or more data item names correlated with the selected template, as analysis data.
